(19) United States
(12) Patent Application Publication
(10) Pub. No.: US 2019/0079348 A1
(43) Pub. Date: Mar. 14, 2019

(54) BACKLIGHT MODULE

(71) Applicants: BOE TECHNOLOGY GROUP CO., LTD., Beijing (CN); BEIJING BOE OPTOELECTRONICS TECHNOLOGY CO., LTD., Beijing, (CN)

(72) Inventors: Zheng WANG, Beijing (CN); Xiuyun CHEN, Beijing (CN); Dake WANG, Beijing (CN); Fei LIANG, Beijing (CN)

(21) Appl. No.: 15/772,216

(22) PCT Filed: Jul. 10, 2017
(86) PCT No.: PCT/CN2017/092354

§ 371 Date: Apr. 30, 2018

(30) Foreign Application Priority Data
Mar. 31, 2017 (CN) 201720333055.3

(51) Int. Cl. G02F 1/1335; F21S 4/28; G09G 3/32

(52) U.S. Cl. CPC G02F 1/133603; G09G 3/32; F21S 4/28

(57) ABSTRACT

A backlight module is disclosed. The backlight module includes: a back plate; an LED light strip arranged on a side of the back plate and along an edge of the back plate; a plurality of heat pipes each of which is disposed on the back plate at the same side as the LED light strips; wherein one end of the heat pipe is respectively adapted to be connected with the LED light strip, and at least part structure of each heat pipe is arranged along a temperature gradient direction of heat on the back plate when the LED light strip is in working state. In the backlight module when the backlight module is dissipating heat, the overall temperature distribution is uniform and local overheating does not occur.

### RELATED APPLICATION

This application claims the benefit of Chinese Patent Application No. 201720333055.3, filed on Mar. 31, 2017, the entire content of which application is incorporated herein by reference.

### FIELD OF THE DISCLOSURE

The present disclosure relates to the field of display technology, and in particular, to a backlight module.

### BACKGROUND OF THE DISCLOSURE

At present, the backlight module on the market generally does not have a good heat dissipation structure. The backlight module without the heat dissipation structure easily leads to the phenomenon that the heat cannot be rapidly evacuated or the backlight module has local overheating. This may cause some damage to the components of a liquid crystal display module adopting such a backlight module and may affect the display effect and life of the liquid crystal display module.

### SUMMARY OF THE DISCLOSURE

An embodiment of the present disclosure discloses a backlight module, which comprises:

a back plate

an LED light strip disposed on a side of the back plate and along an edge of the back plate;

a plurality of heat pipes, each of the heat pipes being disposed on the back plate at the same side as the LED light strip;

wherein one end of each heat pipe is respectively adapted to be connected with the LED light strip, and at least part structure of each heat pipe is arranged along a temperature gradient direction of heat on the back plate when the LED light strip is in working state.

Further, the plurality of heat pipes comprise at least a first heat pipe and second heat pipes symmetrically disposed at both sides of the first heat pipe.

Furthermore, the second heat pipe is provided with a horizontal portion, a bent portion and an extension portion sequentially connected from one end connected with the LED light strip to the other end, wherein the horizontal portion is disposed along the LED light strip and makes an end of the second heat pipe connected with the LED light strip close to the first heat pipe; and the bent portion disposes the extension portion in the temperature gradient direction.

Further, a length of the extension portion is a half of a length of the back plate in a direction perpendicular to the LED light strip, and the minimum distance between the extension portions of the two second heat pipes is three-fifths of a length of an edge of the back plate close and parallel to the LED light strip.

Further, a length of the first heat pipe is three-fourths of the length of the back plate in a direction perpendicular to the LED light strip.

Further, each of the heat pipes and the LED light strip are connected by a thermal conductive adhesive or a thermal grease.

Further, the back plate is provided with a groove for accommodating the heat pipe.

Furthermore, a width of the groove is 0.2 mm to 0.3 mm larger than a diameter of the heat pipe.

Furthermore, a gap between the groove and the heat pipe is filled with a thermal conductive adhesive or a thermal grease.

Further, the backlight module further comprises a fixing member made of a heat conductive material, wherein the heat pipe and the back plate are fixedly connected by the fixing member.

Further, the fixing member is flush with the surface of the back plate.

### BRIEF DESCRIPTION OF THE DRAWINGS

FIG. 1 is a temperature simulation result of a related backlight module in the working state;

FIG. 2 is a schematic structural view of a backlight module of the present disclosure;

FIG. 3 is a temperature simulation result of the backlight module of the present disclosure in the working state;

FIG. 4 is a partial schematic structural view of a backlight module assembly structure according to an embodiment of the present disclosure;

FIG. 5 is a partial schematic structural view showing the installation situation of a back plate and a fixing member in a backlight module according to an embodiment of the present disclosure.

### DETAILED DESCRIPTION OF THE DISCLOSURE

The structure, working principle and the like of the present disclosure will be further described below with reference to the drawings.

When the backlight module of the prior art is used, the overall structure of the backlight module has uneven heat distribution and slow heat dissipation. Therefore, it is necessary to provide a backlight module having a heat dissipation structure matching the heat distribution of the backlight module.

In view of this, the present disclosure provides a backlight module in which at least part structure of each heat pipe is arranged along a temperature gradient direction of heat on a back plate when an LED light strip is in working state. In the backlight module of the present disclosure, when the backlight module is dissipating heat, the overall temperature distribution is uniform and local overheating does not occur.

Generally, the temperature distribution of a backlight module without a good heat dissipation structure is as shown in FIG. 1, in which each isothermal temperature in the figure gradually decreases from one side near the LED light strip to the other side, and the temperatures at positions corresponding to the same isotherm are the same. It can be seen from the figure that the temperature at the middle part on a side of the module provided with the LED light strip is the highest, the temperature on another side of the module away from the LED light strip is the lowest; the isothermal curve is elliptical from the middle part of the LED light strip to both sides. That is, the temperature of the LED light strip decreases gradually from the middle toward the sides of the LED light strip. In such a backlight module, heat cannot easily evacuate rapidly or the overheating of the backlight module may occur, which may cause some damage to the components of the liquid crystal display module using such a backlight module and affect the display effect and the life of the liquid crystal display module

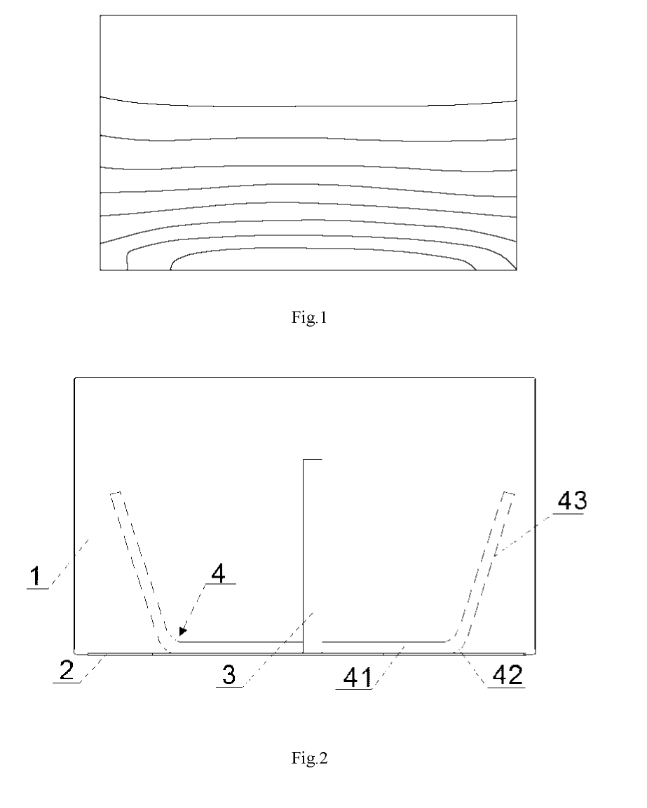

As shown in FIG. 2, the present disclosure provides a backlight module for heat dissipation based on the heat pipe technology, which uses heat pipes to conduct heat and dissipate heat. The heat pipe can be a hollow copper pipe. The inside of the copper pipe is a vacuum chamber. A wick structure braided by copper wires is provided in the chamber and a medium that can easily changes state between liquid phase and gaseous phase such as water or ethanol is filled in the chamber. When one end of the heat pipe is close to the heat source, the medium in the one end of the heat pipe undergoes a phase change due to the heat, changes from liquid state to gaseous state, absorbs a large amount of heat and rapidly moves to one end of the heat pipe away from the heat source and then changes from gaseous state to liquid state and release a large amount of heat, so as to achieve the purpose of rapid thermal conductivity.

In this embodiment, the backlight module includes a back plate 1, an LED light strip 2, and a plurality of heat pipes. The LED light strip 2 is arranged along an edge of the back plate 1, and the plurality of heat pipes are arranged on the back plate 1 at the same side as the LED light strip 2. One end of each heat pipe is respectively adapted to connect to the LED light strip 2 and at least part structure of the heat pipe is arranged along a temperature gradient direction of heat on the back plate 1 when the LED light strip 2 is in the working state. Therefore, the thermal resistance can be effectively reduced for transferring the heat generated by the LED light strip 2, the heat dissipation rate of the LED light strip 2 can be increased, and the heat on one side of the module provided with the LED light strip 2 can be quickly and efficiently transferred to another side away from the LED light strip. Moreover, since at least part structure of the heat pipe is arranged along the temperature gradient direction of heat on the back plate 1 when the LED light strip 2 is in the working state, the thermal resistance can be effectively reduced and the temperature distribution of the module can be changed to reduce the overall module temperature.

Specifically, the plurality of heat pipes comprise at least a first heat pipe 3 and second heat pipes 4 disposed at two sides of the first heat pipes symmetrically. The second heat pipe 4 is provided with a horizontal portion 41, a bent portion 42 and an extension portion 43 sequentially connected from one end connected with the LED light strip 2 to the other end, wherein the horizontal portion 41 is disposed along the LED light strip 2 and makes an end of the second heat pipe connected with the LED light strip 2 close to the first heat pipe 3; and the bent portion 42 makes the extension portion 43 dispose in the temperature gradient direction. Wherein, there is a gap at the butt joint of the adjacent ends of the second heat pipe 4 and the first heat pipe 3, but the gap should be kept as small as possible, so that the heat pipes covers all the LED light strip 2 as much as possible to improve the heat dissipation rate of the LED light strip 2.

In order to obtain a better heat dissipation effect, a length of the extension portion 43 is a half of a length of the back plate 1 in a direction perpendicular to the LED light strip 2, and the minimum distance between the extension portions 43 of the two second heat pipes 4 is three-fifths of a length of an edge of the back plate 1 close and parallel to the LED light strip 2. A length of the first heat pipe 3 is three-fourths of the length of the back plate 1 in a direction perpendicular to the LED light strip 2. It should be noted that “perpendicular to” or “parallel to” here is not absolutely perpendicular or parallel, as long as it can be as close as possible to perpendicular or parallel arrangement.

In this embodiment, the distance and the angle between the heat pipes are determined by simulating the temperature using a simulation software such as Ansys, and the distance between the extension portions 43 of the two second heat pipes 4 ranges from 10 to 400 mm. The angle of inclination of the extension portions depends on the size of the module. The temperature distribution simulation is carried out without the heat pipe, so that the inclination angle is determined from 0 to 90° according to the temperature gradient direction.

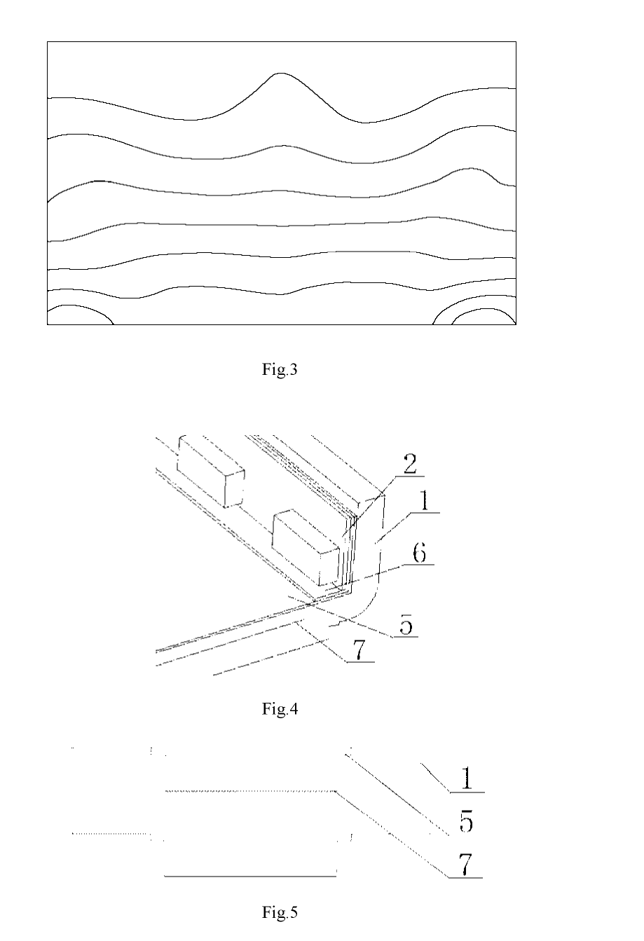

When temperature simulation is performed using the backlight module of the embodiment of the present disclosure, the temperature distribution is as shown in FIG. 3, in which each isothermal temperature in FIG. 3 gradually decreases from one side near the LED light strip to the other side, and the temperatures at positions corresponding to the same isotherm are the same. It can be seen from the figure that the temperature at the middle part on a side of the module provided with the LED light strip is the highest, the temperature on another side of the module away from the LED light strip is the lowest. Compared with the backlight module in the prior art backlight module, the overall temperature is reduced by 10° C., and the temperature distribution changes obviously. The temperature difference between the two ends of the LED light strip and the middle part is not large, which shows that the heat pipes of the embodiments of the present disclosure serve as heat transfer channels evacuating heat, and can prevent the backlight module from overheating locally, thus playing a protective role on the display of the liquid crystal module.

Optionally, the above example and embodiment of the present disclosure may be modified. The structure before and after the modification is largely similar and the principle is the same. The difference is that the heat pipes after the modification are closely connected with the LED light strip 2 through thermal conductive adhesive or thermal grease 6 so that the effect of heat conduction can be better and air can be isolated, improving the dissipation rate of the LED lamp tube 2.

Optionally, the above example and embodiment of the present disclosure may be further modified. The structure before and after the modification is largely similar and the principle is the same.

The difference lies in that, as shown in FIG. 4, the back plate 1 after the modification may further be provided with grooves 7 for housing the heat pipes, which can better integrate the components of the backlight module and the heat pipes. This not only can reduce the surface thermal resistance, so that heat can be transferred through the heat pipes, but also eliminates the effects to the picture quality caused by adding the heat pipes to the backlight module. The cross-sectional shape of the groove 7 may be shapes other than the rectangle shown in the drawing, such as a semicircle, a triangle or the like, as long as it can accommodate the heat pipe.

The width of the groove is 0.2 mm-0.3 mm larger than the diameter of the heat pipe, so that the heat pipe can be conveniently placed in the groove 7. The gap between the groove 7 and the heat pipe is filled with thermal conductive adhesive or thermal grease, which not only plays the role of heat conduction, but also isolates air and enhances the heat dissipation rate.

In order to better fix the heat pipe and the back plate 1, the present embodiment further includes a fixing member 5 made of heat conductive material, such as copper, ceramic or graphite, or any material that can perform good thermal conductivity. The heat pipe and the back plate 1 are fixedly connected through the fixing member 5, the heat pipe is firstly welded with the fixing member 5, the heat pipe is then placed in the groove 7, and the back plate 1 and the fixing member 5 are fixed by reflow soldering method. In addition to the fixing method using the fixing member 5, the heat pipe may be directly welded on the back plate 1 or may be directly fixed to the back plate 1 using thermal conductive adhesive or thermal grease.

In this embodiment, the width of the fixing member 5 can be greater than the diameter of the heat pipe, and when the fixing member 5 and the back plate 2 are fixed, edges of the fixing member 5 are directly welded to the back plate 1; the width of the fixing member 5 may be smaller than or equal to the diameter of the heat pipe. In this case, a plurality of welding points need to be arranged on the fixing member 5, and then welded to the back plate 1 through the welding points. The size and structure of the fixing member 5 can also be changed correspondingly, and the heat pipe can be fixed to the back plate 1.

Meanwhile, as shown in FIG. 5, the fixing member 5 is flush with the surface of the back plate 1 to prevent the optical performance from being affected during assembly.

In the backlight module of the present disclosure, a plurality of heat pipes are disposed on the back plate at the same side as the LED light strip; wherein one end of each heat pipe is respectively adapted to be connected with the LED light strip, therefore the heat generated by the LED light strip in working state can be rapidly dissipated onto the back plate and at least part structure of each heat pipe is arranged along the temperature gradient direction of heat on the back plate when the LED light strip is in working state. In this way, the thermal resistance can be effective reduced. The heat of the backlight module can be conducted from a side of the module provided with the LED light strip to another side of the module without the LED light strip, thereby decreasing the overall temperature of the backlight module and preventing local temperature overheating of the backlight module.

The foregoing is merely a schematic description of the present disclosure, and persons skilled in the art should understand that many modifications may be made to the disclosure without departing from the working principles of the disclosure, all of which fall within the protection scope of the disclosure.

1. A backlight module, comprising:
a back plate;
an LED light strip disposed on a side of the back plate and along an edge of the back plate; and
a plurality of heat pipes, each of the heat pipes being disposed on the back plate at same side as the LED light strip;
wherein one end of each heat pipe is respectively adapted to be connected with the LED light strip, and at least part structure of each heat pipe is arranged along a temperature gradient direction of heat on the back plate when the LED light strip is in a working state.

2. The backlight module according to claim 1, wherein the plurality of heat pipes comprise at least a first heat pipe and second heat pipes symmetrically disposed at both sides of the first heat pipe.

3. The backlight module according to claim 2, wherein the second heat pipe is provided with a horizontal portion, a bent portion and an extension portion sequentially connected from one end connected with the LED light strip to the other end, wherein the horizontal portion is disposed along the LED light strip, and the end of the second heat pipe connected with the LED light strip is close to the first heat pipe; and the bent portion disposes the extension portion in the temperature gradient direction.

4. The backlight module according to claim 3, wherein a length of the extension portion is a half of a length of the back plate in a direction perpendicular to the LED light strip, and a minimum distance between the extension portions of two second heat pipes is three-fifths of a length of an edge of the back plate close and parallel to the LED light strip.

5. The backlight module according to claim 1, wherein a length of the first heat pipe is three-fourths of a length of the back plate in a direction perpendicular to the LED light strip.

6. The backlight module according to claim 1, wherein each of the heat pipes and the LED light strip are connected by a thermal conductive adhesive or a thermal grease.

7. The backlight module according to claim 1, wherein the back plate is provided with grooves for accommodating the heat pipes.

8. The backlight module according to claim 7, wherein a width of the groove is 0.2 mm to 0.3 mm larger than a diameter of the heat pipe.

9. The backlight module according to claim 7, wherein a gap between the groove and the heat pipe is filled with a thermal conductive adhesive or a thermal grease.

10. The backlight module according to claim 7, further comprising a fixing member made of a heat conductive material, wherein the heat pipe and the back plate are fixedly connected by the fixing member.

11. The backlight module according to claim 10, wherein the fixing member is flush with a surface of the back plate.

12. The backlight module according to claim 3, wherein a length of the first heat pipe is three-fourths of a length of the back plate in a direction perpendicular to the LED light strip.

13. The backlight module according to claim 4, wherein a length of the first heat pipe is three-fourths of a length of the back plate in a direction perpendicular to the LED light strip.
